(19) United States
(12) Patent Application Publication
(10) Pub. No.: US 2017/0228218 A1
(43) Pub. Date: Aug. 10, 2017

(54) System and Method for Creating Concurrent Programming Languages by Extending Existing Programming Languages

(71) Applicant: EMILIO SANTOS, MINNEAPOLIS, MN (US)

(72) Inventor: EMILIO SANTOS, MINNEAPOLIS, MN (US)

(21) Appl. No.: 15/017,360

(22) Filed: Feb. 5, 2016

(51) Int. Cl. G06F 9/44; G06F 9/45

(52) U.S. Cl. CPC G06F 8/24; G06F 8/41

(57) ABSTRACT

A system and method for creating a concurrent programming language by extending existing programming languages. The system and method may be useful for extending known concurrent programming languages, such as Java and C#. The system and method provides a compilation process that aids concurrent programming that aids concurrent programming by extending existing programming languages. The extended languages will support signals, concurrent objects, and concurrent expressions. The system and method does not use contracts or futures, but rather uses a different type of object that is understood with a different type of concurrent expression. In one embodiment, an asynchronous object is used.

### CROSS REFERENCE

The present application claims the priority benefit of U.S. Provisional Patent Application 62/089,277 filed 2014 Dec. 9 by the same inventor. The entire contents of the provisional application is incorporated herein by reference.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The present invention is directed to a system and method for creating a concurrent programming language by extending existing programming languages. In particular, the invention proposes the use of expression to achieve process synchronization. The invention only re-interprets expressions, rather than introducing extraneous language constructs.

The inventor is a programmer who develops object-oriented programming languages, and concurrent programming languages. The inventor recognized that programming languages, for the most part, impose a synchronous view on an increasingly asynchronous world. In these languages, operations are totally ordered, so that, given a program's input data, the entire sequence of its computation is determined. However, for better or worse, computation is becoming increasingly asynchronous. At the lowest level, architectural innovation is increasingly focused on improving performance through increased concurrency, with approaches such as simultaneous multithreading or single-chip multiprocessors. Equally significantly, ubiquitous networks make collaboration among programs and users possible, but parallelism and communication introduce asynchrony.

The inventor also knew that programming languages, despite the importance of asynchrony in reactive, event-driven, concurrent, or parallel applications, typically support asynchrony only through library mechanisms, such as threads, events, and synchronization, and provide no linguistic or error-checking features. Lack of support is a serious problem, as asynchrony makes the difficult task of programming even harder, since partially ordered behavior is harder to both understand and analyze and because nondeterminism obscures the cause of errors.

Those skilled in the art, in light of the present teachings, will recognize that the o d is asynchronous, yet most programming languages not. This is not due to the lack of trying, a brief survey will show that concurrent languages were developed more than forty years ago. Presently there are more than fifty concurrent languages. The invention presented herein lists and discusses several implementations of a classical dining philosopher's problem that was developed to explain the problems associated with concurrent programming. Said implementations and related discussions present a sufficient sample size to deduce that:

Methods vary wildly, as do the syntactic artifacts used to realize said methods.
Very few of said methods are obvious to understand to any with basic skill in the art.
Some of said methods require high levels of skill in the art to understand.
The complexity doesn't seem to be proportional to the complexity of the stated problem.

Just to name a few observations. The goals of the present invention include the improvement of computer-related tools intended to increase simplicity, safety, parallelism, synchronization and similar when applied to programming languages extended by the present invention.

Thus, the present system helps streamline web pages related to concurrent programming languages. However, it should be clear that the arguments so far made in this background are not expected to be deemed true based on the references provided. Said references shall be considered anecdotal, yet said references also do not show any indication of being false and match empirical observations. Most of the references represent concepts that are considered public-domain.

The present invention has identified, without the assumption of completeness; three traditional approaches to solve the notoriously difficult problem presented in this introduction. Such approaches are listed next and expanded upon shortly thereafter. As part of said expansion, patents considered to be relevant shall be disclosed and compared to similar or equivalent aspects of the present invention. The result of said comparisons, in the context of the present invention and its detailed description; shall make evident that the present invention is, in fact; novel and useful.

An approach based on custom programming languages.
An approach based on libraries written for existing programming languages.
An approach based on extending existing programming languages.

The first approach is based on the premise that augmented syntax, usually with augmented semantics related to said syntax; should facilitate concurrent programming. It is impossible to detail all features of all the listed languages, except to assert that to our knowledge, none of the languages reviewed include the disclosed aspects of the present invention. A few examples of said augmentations include: channels, go routines, messaging statements, contracts and futures. It is in the spirit of the present invention to consider said augmentations of lesser value and, if not alone, as a whole: the main contributors of today's over-complicated programming languages.

Simplicity is universally acknowledged as one of the most desired properties of any programming language and the present invention aims to achieve its goals while providing simplicity presently unprecedented in the realm of concurrent programming languages. Our claim to simplicity is validated by the fact we only re-interpret expressions as opposed to introducing extraneous language constructs.

These languages, further validating the spirit of the invention, have not been able to become mainstream and have found limited success in mainly in niche markets. A brief survey of language popularity rating ranks the three most popular of said languages to be Scala (#31), Go(#41), and Erlang (#42), all comprising 1.214% of popularity. The statistics just presented are not intended to be precise or to prove any assertions, but are referred to present to the reader a general picture that seems to match empirical observations. Further, said languages are known suffer from lack of robust software stacks when compared to mainstream programming languages (such as C#, Java, javascript, c++, etc), which further alienates developers, further confirming diminished value in the languages.

The present invention cites US Patent U.S. Pat. No. 5,867,649A as an example of the said approach to concurrency. The patent describes a custom programming language meant to aid parallel computation programming by means of a state lattice and parallel expression evaluation. The present invention, While rider in scope is configured to extend existing languages instead of claiming a new one. The invention also uses custom processing of expressions for purposes of concurrency, including parallel computation. However, said patent's stated goals are centered around said computation while the goals of the present invention are closer to process synchronization. A case could be made as for said synchronization to be a more difficult goal to realize as well as more useful when compared to computation.

Further, the present invention shall make clear that it is capable of enabling said computation using aspects of the invention intended for said synchronization goals. As such, it shall be clear that the present invention goals are an augmented set of the patent goals. As such, the disclosed concurrent expression aspect of the present invention shall be acknowledged as novel when compared to the equivalent aspect of said patent. Furthermore, the present invention does not contain, reference, use or relate to the concept of state lattices which is central to said patent's claims.

A second approach to concurrency, general purpose languages; attempts to solve said problems by providing the minimum set of tools to avoid problems associated with concurrency. Said tools typically include operating-system level mechanisms such as threads, critical sections, semaphores, etc. It is widely accepted that using said mechanisms is difficult to realize, difficult to diagnose and often dangerous to the continuing execution of computer programs. Another embodiments of said approach offer developers highly specialized libraries which, in turn, introduce several new concepts. Said new concepts often involve very distinctive syntactic patterns of use and as such should be considered semantically equivalent to the augmented syntaxes as described in the first approach and as such known to suffer of the same limitations of said syntaxes.

The present invention cites US Patent U.S. Pat. No. 7,774,750B2 as an example of the said approach to concurrency. In said patent, a specialized library is defined to aid concurrent programming by adding a set of novel concepts such as “ports”, “dispatchers” and “arbiters”. Said patent utilizes elements of process calculus. The present invention, while sufficiently different in its approach (language extension vs utility library), does support elements of process calculus and considers said calculus to be of public domain.

Further, the present invention does not contain, reference, use or relate to any of the novel concepts as disclosed in said patent. Furthermore, the present inventions considers the patent to be part of a family of patents which may contain functionality or concept overlap with the present invention. The present invention intends to be considered, at worst, as equivalent to said family of patents. Such a well-researched topic is bound to produce said overlaps, particularly considering the large sample size. However; the petitioner attest to not have any of said overlaps to be more significant than the patent's.

Yet a third approach to concurrency, as listed and considered to be the preferred approach; is programming language extensions. An extended language provide developers with all benefits of general purpose languages. Said benefits include, but are not limited to: software stack, development tools and familiarity. Conversely, said approach also provides all benefits of custom programming languages. For example: the ability to produce domain specific errors and warnings and the ability to further add meaning via declarative modifications. The declarative modifications can be understood as aesthetic-oriented syntax changes often used to differentiate the aspects of the present invention. Further, it is in the spirit of the invention to reuse language existing artifacts and to consider the introduction of new semantic constructs via syntax modification to be value diminishing shall it be used in a particular embodiment.

The present invention cites US Patent U.S. Pat. No. 7,694,276B2 as an example of the said approach to language extension. Said patent proposes an extension to the C# language which in turn defines new language constructs in the form of “contracts” and “futures”. The present invention considers said patent to be an almost perfect equivalent to the present invention. Said equivalence is proved by the overwhelming overlap of goals between said patent and the present invention, examples of which are: to extend a programming language in order to aid concurrent programming and to create executable code representative of said language extensions.

However, the present invention shall note the distinctiveness of the means offered to accomplished the overlapping set of goals. The present inventions offers a general mechanism to extend a subset of the languages (which includes C#). As such, the present invention should be considered more general when compared to the patent's goal of extending C#. Further, the present invention is capable of said language extensions without the need for novel semantic concepts to be added to the extended language syntax.

Thus what is needed is an improved concurrent programming language, system or methodology that mitigates some of the aforementioned shortcomings of conventional languages.

The present invention provides a preferred embodiment which includes one language service as disclosed in the abstract which is compatible with the C# language. Conversely, said embodiment includes an embodiment of the compilation method aspect interoperable with said language service. Conversely, said embodiment includes one runtime service as disclosed in the abstract which, among others responsibilities; executes code provided by said compilation method embodiment. As such, said preferred embodiment evidently provides means to accomplish the goals of the present invention. Furthermore, said preferred embodiment shall include examples which, when compared to the equivalent examples provided will allow those skilled in the art to appreciate the novelty and the added value of the present invention. Furthermore, said preferred embodiment shall be proof and reference of the spirit of the present invention as disclosed in this background as a whole.

Those skilled in the art should recognize and appreciate the preferred embodiment’ simplicity and guarantees as a significant improvement of the art. Further, said skilled in the art should also recognize and appreciate the need of the present invention, for the preferred embodiment of the present invention allows its method to be used in a compiler of computer system in order to extend other programming languages so that the extended language becomes a concurrent language. Furthermore, those skilled in the art should be able to deduce possible uses and variations of the present invention.

Systems and methods for enhancing programming languages have been utilized in the past; yet none with the characteristics of the present invention. See U.S. Pat. No. 7,693,276; U.S. Pat. No. 5,867,649; and U.S. Pat. No. 7,774,750.

For the foregoing reasons, there is a system and method for creating a concurrent programming language by extending existing programming languages.

### SUMMARY

The present invention describes a system and method for creating a concurrent programming language by extending existing programming languages. The system and method may be useful for extending programming languages, such as Java and C#. However, the system and method only re-interprets expressions as opposed to introducing extraneous language constructs.

In one aspect, the invention provides a compilation method for extending existing programming languages by evaluating a concurrent expression in the context of a concurrent object, the method comprising:

providing a formal definition of a subset of services intended to realize the compilation process;

supporting a programming language and a runtime environment;

defining a set of constraints imposed on the subset of services;

transforming an input expressed in the language being extended into a concurrent expression, the concurrent expression configured to be executable by the runtime environment;

evaluating the a concurrent expression by means of a concurrent expression tree;

maintaining the state of the executing concurrent expressions from its initial state to its completion over time, whereby non-blocking capabilities are utilized;

evaluating the concurrent expressions by means of a hierarchical bitset;

creating 2 bits per operand and express operators as cascading binary operations over all bits in the concurrent expression; and

synthesizing a hardware configuration for the concurrent expression, whereby non-blocking capabilities are utilized.

The system and method provides a compilation process that aids concurrent programming by extending existing programming languages. The extended languages may support signals, concurrent objects, and concurrent expressions.

The system and method provides a formal definition of a subset of services intended to realize the compilation process. The services are understood to be trivial to realize and are classified as “language services” or “runtime services”. The services shall support an underlying programming language and runtime environment, respectively. The system and method defines a set of constraints imposed unto those systems to guarantee. The constraints are intended to be specific, finite and mostly trivial to understand and realize in the services.

The satisfaction of certain sets of the constraints provides developers a set of guarantees regarding performance, safety, accessibility and otherwise. The set of guarantees is universally regarded as desirable in the context of concurrency. Examples of the guarantees include, among others, data-race safety, deadlock safety and non-blocking execution.

In one embodiment, language services will transform an input expressed in the language being extended into an output also expressed in the language. The output is understood as a concurrent version of the input and shall be executable by the runtime service by means such as interpreters, compilers and similar.

In one embodiment, language services will produce a computer-related artifact such as an executable file which can be directly executed in a related computer-related environment, such as an operating system.

Those skilled in the art will recognize that concurrent programming languages use concepts of simultaneously executing processes or threads of execution as a means of structuring a program. Many of the concepts have been proposed in the art such as contracts and futures. The present invention does not use any of the concurrent concepts. Rather, it evaluates concurrent expressions in the context of a concurrent object. This evaluation uses processes as it operands and results in the synchronization of the processes. The present invention guarantees that any software operations (i.e, instructions) that follow a concurrent expression will not be executed until the expression terminates. Such termination is determined over time depending on the results of the expression operands along with system communications, such as signal invocations.

In one embodiment, a language service is provided so the evaluation occurs in non-blocking fashion. This property is better understood as a guarantee that the execution of expression-related operations will complete in bounded time and not block the calling execution thread. Those skilled in the art will recognize the importance of this feature in regards to simplicity and scalability.

Another aspect of the invention introduces signals, a language artifact which models the concurrent concept of a message. The signals are unique in the sense they model both the receive and send operations of a message. The operations are considered processed and therefore acceptable as an operand in concurrent expressions.

In one embodiment signals are referenced by name to denote a wait-for, or receive, operation. Conversely, the invocation syntax is used to denote the send operation. In the embodiment, the signal may be simply specified as a traditional object oriented method. Those skilled in the art would notice this embodiment is realized without modifying the syntax of the programming language being extended.

Another aspect of the invention introduces concurrent objects, a language artifact intended to provide orchestration between several concurrent expressions. The objects are defined as independent units of execution and may contain several expressions not fully evaluated. The objects are able to expose an unlimited number of signals to the computer-related system containing the concurrent object.

In one embodiment, concurrent objects are modelled as traditional object oriented classes and are equivalent the well-researched concept of an actor as defined in the actor model of concurrency.

In one embodiment, the system and method provides an algorithm to evaluate concurrent expressions by means of a concurrent expression tree. The algorithm maintains the state of an executing concurrent expressions from its initial state to its completion over time. The algorithm provides non-blocking capabilities to the system.

In one embodiment, the system and method provides an algorithm to evaluate concurrent expressions by means of a hierarchical bitset. The algorithm creates 2 bits per operand and express operators as cascading binary operations over all bits in an expression. In another embodiment, the algorithm is used to synthesize a hardware configuration for a concurrent expression. The algorithm provides non-blocking capabilities to the system.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### DRAWINGS

These and other features, aspects, and advantages of the present invention will become better understood with regard to the following description, appended claims, and drawings where:

FIG. 1 is a show chart of one of the embodiments of the present invention;

FIG. 2 is a Venn diagram that shows how the complier of the present invention interacts with the required services to accomplish concurrent programming;

FIG. 3 shows a flow chart that describes the data flow of the present invention;

FIGS. 4a and 4b show flow charts that shows the code splitting process used by concurrent expressions; and

FIGS. 5a and 5b show diagrams of electronic circuit, where FIG. 4A illustrates Signals As, Bs and Ls representing incoming signals signifying the success of their respective processes, and FIG. 4b illustrates Af, Bf and Lf represent incoming signals signifying the failure of said processes.

### DESCRIPTION

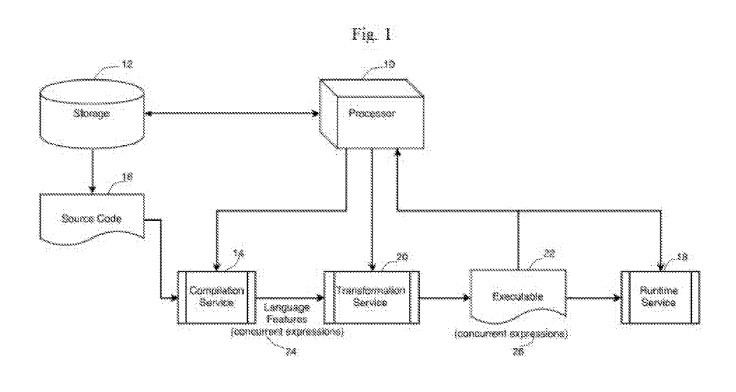

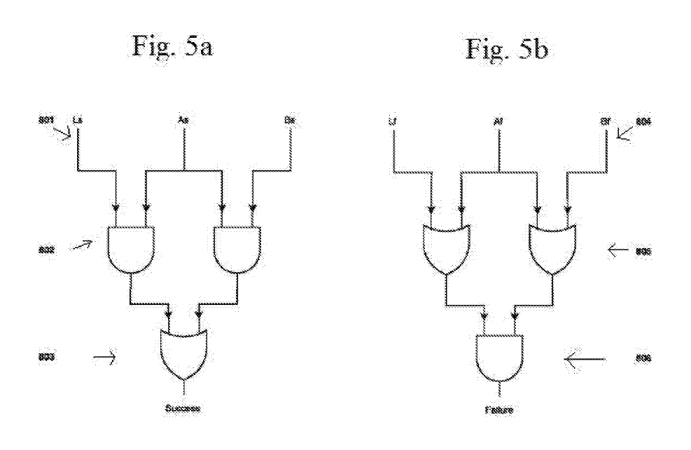

The present invention, referenced in FIGS. 1-5b, is directed to a system and method which provides a compilation process that aids concurrent programming by extending existing programming languages. The extended languages support signals, concurrent objects, and concurrent expressions. The system and method does not use contracts, futures or similar concurrent artifacts, but rather evaluates concurrent expressions in the context of a concurrent object.

The present invention will now disclose specific details regarding the process and method employed as to accomplish the intended goals which include transforming software entities provided in the form of a general parse tree by a language service into an equivalent entity representing a concurrent object. Further, said goals include transforming said concurrent object into a computer-related artifact which shall be executable by a runtime service which in turns accomplish the ultimate goal of producing concurrent computer programs. Further, said goals include providing the means to make said programs efficient in terms of execution and storage.

For the remainder of this document the term “entity” shall refer to any computer-related entity realized by means of software, hardware or any combination thereof Conversely, the term “compiler” shall refer to the compilation method aspect of the present invention as disclosed herein. Conversely, the term “runtime” shall refer to a runtime service, as described herein; used by a compiler. Conversely, the term “language service” shall refer to a language service that is used by the present invention. Conversely, the term “source” shall refer to a computer-readable artifact related to the language service underlying programming language, which is compatible with both the =time and the language service, said source is, in fact, the input which the invention transform into a computer program.

All references to programming language syntax used throughout this document shall be regarded as pertaining to the preferred embodiment syntax unless otherwise specified. The present invention acknowledges that different embodiments may differ syntactically (for example, because of operator support while extending an existing language) and intends to cover all such syntaxes as long as they are in the spirit and within the disclosed parameters of the invention. Further, the present invention intends to cover all trivial syntactic changes meant to differentiate aspects of the present invention. An example of said changes is the preferred embodiment, which allows C# classes to accept the otherwise invalid modifier “concurrent” for classes and allows the omission of the semicolon token to signify concurrent expressions.

All tables presented throughout this application may offer an “Abbreviation” column by which the contents of each row shall be referred to later on.

FIG. 1. shows a diagram depicting the relationship between the main aspects and/or services of the present invention. A compiler 100 shall be capable of accomplishing the stated goals while offering a set of guarantees 102 as long as at least one suitable language service and one suitable runtime service exist in the area denoted by compiler 100. The intersection of all runtime services 101 and all language services 103 shall denote pairs where both support the same underlying programming language and meet the constraints associated with said guarantees 102.

Formally, the present invention can be described as:
concurrent program runtime(compiler(language(source)))

For the sake of clarity, the details that will be presented assume a source that relates to an object oriented underlying programming language. Further, such details will assume the language service to support abstract syntax trees. The present invention acknowledge circumstances where these assumptions might not be true due to unsupported constraints, however; said details should mostly apply in such circumstances which could be considered exceptional. Under said assumptions, and without losing generality; we can define a “compilation tree” as an entity which models the abstract syntax trees concept. Further, said tree shall provide any and all information needed by the compilation process, as defined in the context of the present invention; to accomplish the intended goals.

Examples of said information include: syntax trees for multiple type artifacts, build scripts, semantic information and similar. Said trees are to be referred to sometimes as “syntax tree” or simply “tree”. Conversely, the term “type artifact” will be used to refer to members of an object oriented entity in the accepted literature. Examples of said members include, but are not limited to: methods, properties, fields, constructors, events, and the like.

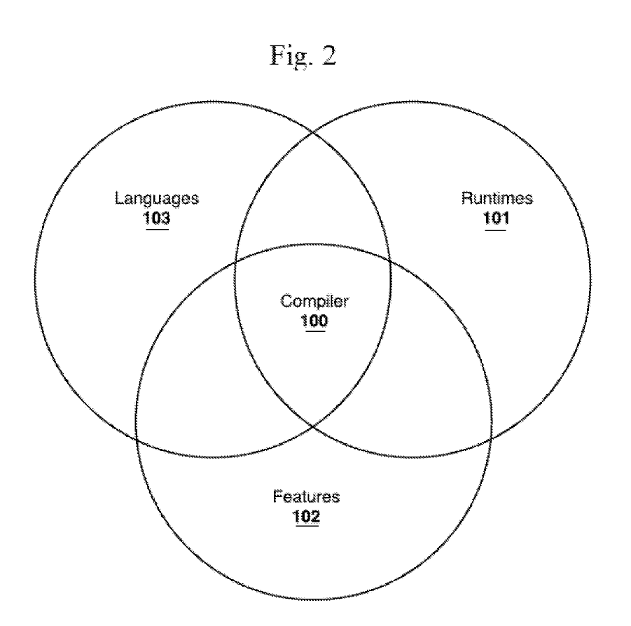

FIG. 2. shows a flowchart that represents a typical data flow of the compiler 200 as defined by the present invention. Said flow is intended to be applied to a single object oriented artifact included in the input tree 201. It shall be obvious that applying the compilation process to all said artifacts in the said input tree shall accomplish the stated goals.

Provided is the signal collection module 202 which responsibilities include analyzing the input 201 in order to detect and collect all type artifacts identified as signals by the language service. In the preferred embodiments, signals are identified as any public method of a concurrent object. The present invention covers any form of signal identification.

Disclosed is the entry point collection entity 203 that functions in a manner similar to the signal collection module 202, only that it looks for a particular type artifact that will be identified as the entry point for the concurrent object as defined herein. In the preferred embodiment, the entry point is identified as a method “main.” The present invention covers any means of entry point identification.

Further disclosed is the signal compilation entity 204 that detects and collects concurrent expressions on any code associated to a signal. Further, said entity shall synthesize a type artifact for all such code.

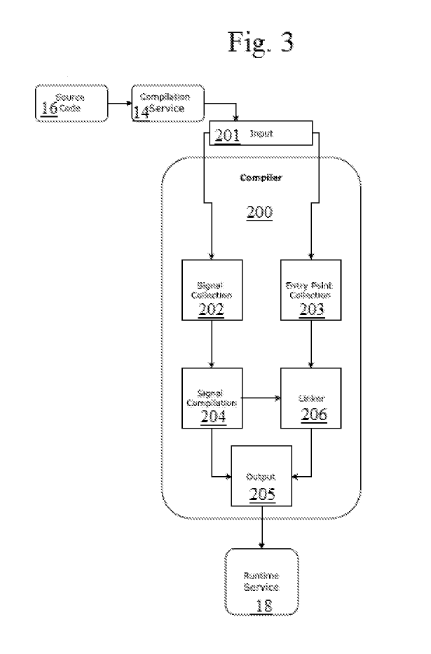

FIGS. 3A and 3B provide an overview of said synthesized code. Provided is an original code 300 which shall be equivalent to a provided result code 301 except for said result to be able to stop at the statement preceding the said concurrent expressions and to be able to restart execution at the statement following the said concurrent expressions as requested by the runtime. Said result is added to the output 206. The present invention makes no claims over any algorithm used to realize said result, however; it considers said algorithm to be of public-domain. To that effect, the present invention references so-called open source projects released publicly by the inventor. Further, and to said effect, the preferred embodiment of the invention is implemented by means of C# enumerables, adding to the claim of public domain for said algorithm.

Furthermore, in FIG. 2, there is provided the linker entity 205 which operates in a similar manner to the signal compilation module 204 regarding the entry point of the concurrent object being realized as provided by the entry point collection module 203. In addition, said linker's responsibilities include synthesizing a set of type artifacts in turn responsible for synchronization. Said artifacts shall be expanded upon later in this application. Further, said linker shall configure the concurrent object being synthesized so the runtime executes said entry point at time zero in a concurrent object's lifetime.

In the next sections the concepts herein introduced by the present invention shall be described in detail as to provide a complete understanding of its aspects and their novelty. The following details are, however, representative of but a few of the uses and functionality of the concepts presented. The present invention means to cover all such uses, functionality and equivalent.

Constraints are as follows:

The stated goals for constraints, as defined herein; include guaranteeing functionality to be present in computer related entities. Further, said goals include aiding the compiler in determining the available feature set. Said determination can be accomplished entirely by analyzing constraints met by both the language and the runtime service. It shall be clear that constraints sets are not meant to be provided in its entirety. However, the larger the set of constraints met by related services shall impact directly the set of features and guarantees the present invention means to offer.

Theoretically, said constraints could form a set to be considered mandatory. Such set shall be defined as the minimum set of constraints needed for the present invention to be correct or useful. Said set could prove difficult to determine, for example: An embodiment may choose to drop constraints related to concurrent objects while still using the synchronization features of the present invention. The present invention intends to cover all such variations.

The Compiler is as follows:

The compiler's stated goals include providing an entity capable of synthesizing concurrent objects based on an input as defined herein and provided by the language service. To that effect, said compiler imposes a set of constraints, as defined herein; and listed in Table 1. Said constraints are applied to said input. Further, said compiler shall provide users with a set of guarantees intended to ease concurrent programming. Table 2 shall list a set of such guarantees, however; said lists are presented as just but a few of the possible guarantees and constraints allowed by the present invention. Those skilled in the art should easily recognize the extensibility of said set of constraints and guarantees. The present invention means to cover all such constraints and guarantees.

Furthermore, said goals include synthesizing synchronization information capable of maintaining a state which shall satisfy concurrent expressions as described herein. A method intended for the accomplishment of such goal is disclosed in the section dedicated to said expressions.

Furthermore, said goals include to provide users with core functionality related to concurrency. Examples of said functionality are: wait, timeout and failure.

The following is a Table showing the list of Compiler Constraints:

| | Abbre- | |
|---|---|---|
| Description | viation | Meaning and Remarks |
| visibility | CC1 | Concurrent objects shall have no members |
| constraint | | publicly visible other than signals. |
| data transport | CC2 | Signals shall only transmit value types |
| constraint | | and concurrent objects. |
| creation | CC3 | Concurrent objects shall not be user- |
| constraint | | instantiable. |

The following is a Table showing a list of Compiler Guarantees

| | Abbre- | |
|---|---|---|
| Description | viation | Meaning and Remarks |
| guarantee of | G1 | Concurrent objects are guaranteed to be |
| single- | | single threaded, defined as only one path of |
| threadedness | | execution involving said object active at a |
| | | single point in time. |
| guarantee of | G2 | The internal state of a concurrent object |
| thread-safety | | shall be considered safe to access and |
| | | modified at all times. |
| guarantee of non- | G3 | No interaction of concurrent objects shall |
| deadlock | | cause deadlock. |
| guarantee of | G4 | Shall a concurrent operation fail, said |
| failure correctness | | exceptions shall be handled correctly. |
| guarantee of | G5 | Computer-related processors used by the |
| reasonable uptime | | runtime to execute concurrent objects shall |
| | | be executing user code the vast majority of |
| | | its time. |
| | | Remarks: These guarantee is related to the |
| | | time concurrent systems spend in non-user |
| | | code such as in locks, context changes and |
| | | the such. |
| guarantee of | G6 | Said G5 processors shall only execute user |
| optimal uptime | | code, in practical terms. |

The implementation of some of these guarantees is considered trivial, for example, G1 can be implemented by means of entering a hardware lock whenever a signal is received. However, for the sake of completeness, Appendix 1 is provided as an implementation reference.

The Runtimes Services are as follows:

A runtime service or runtime is an entity, as defined in the context of this invention; which is capable of understanding a particular programming language. Further, a runtime shall be capable of transforming a compatible parse tree, as defined in the context of the invention; into executable form. Furthermore, a runtime shall be capable to execute said executable form in a computer-related entity. Furthermore, said runtime shall meet a set of constraints as defined herein. Table 3 presents a list of said constraints.

The following Table lists Runtime Constraints:

| | Abbre- | |
|---|---|---|
| Description | viation | Meaning and Remarks |
| messaging constraint | RC1 | The runtime must allow messages to be |
| | | exchanged between entities related to |
| | | the runtime. |
| signal exclusivity | RC2 | The runtime's representation of a |
| constraint | | concurrent object shall process only |
| | | one signal at a time. |
| signal rejectability | RC3 | Said RC2 object shall be able to reject |
| constraint | | signals. |
| signal observability | RC4 | The runtime's representation of a signal |
| constraint | | should be observable while in process |
| | | of transport. |
| object management | RC6 | The runtime shall provide functionality |
| constraint | | as to manage multiple said objects. |
| core functionality | RC7 | The runtime shall provide support to |
| constraint | | the core functionality as required by the |
| | | compiler. |
| | | Examples of said functionality: wait, |
| | | timeout, failure. |

Those familiar with the art will recognize the fact that most of the constraints imposed unto runtimes are trivial to satisfy using public-domain tools. For example: the preferred embodiment uses a runtime composed by the .net framework, Microsoft build tools, an open source messaging library and a custom library for actor management. Those familiar with the art should be able to imagine similar setups for other programming languages and platforms.

The present invention does not make any claims over said runtime services except that they exist and are trivially realizable as defined herein.

The Language Services are as follows:

A language service or language is an entity as defined in the context of this invention. Said service is capable of understanding a particular underlying programming language. Further, said service should meet a set of constraints as defined herein. Table 4 presents a list of language constraints.

The following Table lists Language Constraints:

| | Abbre- | |
|---|---|---|
| Description | viation | Meaning and remarks |
| paradigm | LC1 | The underlying programming language |
| constraint | | must meet the established criteria for |
| | | object oriented languages. |
| | | Failing this, the language service must |
| | | offer a transformation between the |
| | | underlying programming language and a tree |
| | | representation which meet the established |
| | | criteria for object oriented languages. |
| structure | LC2 | The underlying programming language |
| constraint | | must be representable by a parse tree. |
| identifi- | LC3 | The language service must be able to |
| ability | | identify, from a parse tree; most of |
| constraint | | following type artifacts unambiguously: |

| a) | object oriented artifacts identified as |
|---|---|
| | concurrent classes. |
| b) | type artifacts of said classes. |
| c) | type artifacts of said classes identified |
| | as publicly accessible. |
| d) | type artifacts of said classes identified |
| | as publicly accessible properties or |
| | fields. |
| e) | type artifacts of said class identified |
| | as signals |
| f) | type artifacts of said class identified |
| | as entry point |
| g) | statements. |
| h) | statement identified as concurrent |
| | expressions. |
| i) | components of concurrent expressions. |
| j) | any other information useful to the |

process.

| | | |
|---|---|---|
| safety | LC4 | The underlying language shall support |
| constraint | | exception handling. |
| minimum | LC5 | The underlying programming language |
| operator | | shall support at least logical operators. |
| set constraint | | |

Those familiar with the art will recognize the fact that most of the constraints imposed unto a language are trivial to realize as defined herein. For example: the preferred embodiment uses a language service built on top of the Microsoft code analysis tools. It should. be trivial to imagine similar setups for other programming languages. For example: a scenario where a public-domain grammar is available for one object oriented language. Plenty of tools are available to transform source code into parse trees. Further, is likely that said language will meet the constraints listed above for the underlying programming language, since most known languages do. Furthermore, only the identification constraint shall remain which any familiar with the art shall acknowledge to be trivially realizable. Furthermore, said grammar is likely to be trivially extensible.

The Concurrent Objects are as follows:

The stated goals of concurrent objects include to offer users an entity which functions as an independent units of execution. Further, said goals include support for signals, as defined herein; that shall enable safe communications with other such objects. Furthermore, said goals include the management of multiple suspended execution threads by means of concurrent expressions.

Concurrent objects are expected to be stateful entities often found in a synchronization state where a set of signals is needed in order to resume a predefined execution path. Certain guarantees listed in Table 1 apply directly to said objects such as being single threaded and thread safe.

Provided in Table 6 is an excerpt of a solution to the dining philosopher problem presented in the background of the present invention. Columns in said table shall show example source code as defined herein or numeric identifiers meant to refer to a particular line of code to its right. The discussion of said source shall reference said lines using said identifiers.

Provided is a line 400 which declares a concurrent class, said declaration embodies the trivial declarative syntax changes as discussed herein. Instances of said class shall embody the concurrent object aspect of the invention.

Provided is a line 401 which declares a method that embodies the entry point concept as defined herein. Further, the said line shows a set of parameters needed for the concurrent object to start executing. In this particular case, and according to the parameters of the problem; philosophers are assigned the chopsticks they shall use to eat.

Provided is a line 402 which shows the embodiment of the concurrent expression aspect of the invention. The meaning of said expression shall he obvious (to wait a few minutes and then go hungry), which furthers the accomplishment of the goals stated by the invention. Further, said line embodies the core functionality as described herein. Furthermore, the identifier “hungry” embodies the signal aspect of this invention. Furthermore, the code “hungry( )”, pertaining to said expression; embodies the invocation or dispatching of a signal as described herein. For reference, a line 405 is provided which embodies the other described use for signals: the wait operation. Said invocation, in the example; causes the philosopher to try to acquire his chopsticks. Conversely, said wait operation causes the chopstick to enter a synchronization state, as described herein; where only one “acquire” signal is accepted. Said expressions, by virtue of their simplicity, readability and expressiveness; shall be considered to further the stated goals of the present invention.

Provided are lines 403 and 404, which further exemplify the spirit of the present invention. Any skilled in the art should easily infer, by simple inspection that:

a philosopher will never eat unless he is able to acquire both his chopsticks.
chopsticks should always become available in a finite time (between 3 and 5 minutes)
no philosopher will starve

Those skilled in the art would appreciate said inference is considered a much harder task in most other implementations as provided in Appendix 3. Thus, and in conjunction with all disclosures regarding said sample; the present invention shall consider said example to be sufficient proof of improvement in the art of concurrent programming.

The following Table 6 illustrates an excerpt from the Dining Philosopher problem:

| | | |
|---|---|---|
| 400 | concurrent class philosopher | concurrent class chopstick |
| | { | { |

| | | |
|---|---|---|
| 401 | void main(chopstick _left, chopstick _right) | void main( ) |
| | { | { |

| | | |
|---|---|---|
| left = _left | 405 | [symbol] |

| | | |
|---|---|---|
| | right = _right | } |
| 402 | [symbol] (minutes = [symbol] (3, [symbol] )) | public void [symbol] |

| | |
|---|---|
| [symbol] hungry [symbol] | { |

| | |
|---|---|
| } | release |

| | } |
|---|---|
| void hungry( ) | |
| { | pub [symbol] void release( ) |

| | | |
|---|---|---|
| 403 | left [symbol] & right [symbol] | { |

| | |
|---|---|
| [symbol] ; | [symbol] |

| | |
|---|---|
| } | } |

}

void [symbol]
{

| | |
|---|---|
| | [symbol] (minutes [symbol] (3, [symbol] |
| 404 | [symbol] & right [symbol] |

} [symbol]
chopstick left; [symbol]
chopstick right;

} [symbol]
indicates data missing or illegible when filed

The Signals are as follows:

The stated goals for signals include providing a mechanism for inter-concurrent-object communication. Further, said goals include providing a mechanism useful to realizing the synchronization goals of the invention. Said synchronization shall be accomplished in conjunction with concurrent expressions as defined herein. Furthermore, said goals include providing a set of semantics related to both said signals and its operations. Furthermore, said goals include providing support channels.

An apt comparison for signals is a message as traditionally defined in computer-communication literature. A signal could be understood as capable of both sending and receiving messages. Sending messages provide means of communication while receiving messages provides means of synchronization. In fact, it is recommended that runtime services use a strong messaging library such as the one used by the preferred embodiment.

Signals by means of inclusion transform traditional expressions into concurrent expressions. Furthermore, the compiler considers that any expression containing signals in any of the uses is in fact a concurrent expression.

When a message representing a signal is received, as the result of an invocation, the code associated with said signal shall be executed. Said code shall be executed even if a synchronization state is active. Further, said code may itself contain concurrent expressions which would then augment said synchronization state to include said expressions. This mechanism provides means of communication that shall be deemed helpful to concurrent programming.

Signals, as previously disclosed, are expected to provide some semantics intended to offer control over signal events. Said semantics are in part provided to satisfy a need which can be stated as the lack of decision making information in the event of a signal rejection (shall this be a valid signal or not). Said semantics shall provide the runtime with said decision making information. For example, upon signal rejection said semantics could indicate the runtime should:

Drop the signal
Enqueue the signal for short term retry.
Schedule the signal to be resent a certain amount of time into the future.
Schedule the signal after trying short term a certain amount of times.

These are just but few of the decision making choices signal semantics can offer, the present invention intends to cover all such choices. Further, signal semantics can be used for purposes of notification. When sending a signal to a concurrent object, the initiator of said send operation could need to be notified of:

when the signal was received and processed.
when the signal was received.
when the signal has been acknowledged, i.e considered valid but not yet received, for example, when queued.
when the receiving object state does not allow this signal

These are just but few of the notification choices signal semantics can offer, the present invention intends to cover all such choices. Further, signal semantics can be used for purposes of process calculus. The present innovation, up until now, has clearly met most the criteria of the actor model of concurrency. Process calculus, however, has a requirement of support for multiple communication channels. Signal semantics are used to provide support for said channels in ways that shall become evident by reviewing the example presented in Table 7. Said example shows a preferred embodiment, which extends the C# language; using an unlimited number of named parameters to communicate signal semantics:

Provided in said example is a line 700 showing the invocation of a signal expected to be dropped if rejected.

Provided in said example is a line 701 showing the invocation of a signal expected to be delivered on a named channel.

Provided in said example is a line 702 showing the invocation of a signal expected to notify of its acknowledgement by a concurrent object in the context of a concurrent expression.

The following is an example of Signal Semantics:

concurrent_object.SIGNAL(drop_on_rejection=true);
concurrent_object.SIGNAL(channel=“some channel”);
SIGNAL1|concurrent_object.SIGNAL2(acknowledged=true)

The example just disclosed shows but one of the possible constructs already available in existing languages that can be used to express signal semantics, other well-established variations of said constructs include, but are not limited to: attributes, trivia and naming conventions. The present invention intends to cover all said variations.

The Concurrent Expressions are as follows:

The stated goals for concurrent expressions include providing synchronization points for concurrent objects. Said synchronization points are defined as suspended execution threads which will resume only after said expression completes. Further, said goals include modifying the state of the concurrent object where only a set of signals are allowed to be received. Furthermore, said goals include providing communication means while in said synchronization state. Furthermore, said goals include to provide mechanisms for parallel computation.

Concurrent expressions are not only limited to include signals but also to general processes. Said processes can include: computation results, signal invocations and the like. It is worth noting that requests are converted into signals internally by means of creating anonymous signals expected as the result of the completion of said processes. For instance, should an operand on a concurrent expression denote an invocation on another concurrent object (i.e. another_object.signal_name( . . . )), then an anonymous signal will be created and triggered by the runtime once the original invocation completes.

Concurrent expressions provide means of communications while in synchronization state by several possible means. Arguably the most common of said means is by executing code associated with signals as said signals are received. Another such means is by executing lambda expressions, as described herein; where such constructs are available.

Concurrent expressions modify the semantics of several operators in order to provide the intended functionality. The following table contains a list of operators which semantics have been modified to fit the present invention. However, these are but a few of the possible operators and the syntax pertains to the preferred embodiment. The present invention means to cover all possible operators and syntaxes.

The following Table illustrates expressions:

| Operator | Semantic | Example |
|---|---|---|
| Logical | Both the left and right | A && B, A & B |
| AND | operands must be complete | The system must receive |
| &&, & | in order for the expression | and process both signals |
| | to be complete. | A and B. |
| Logical | Any of the left or right | A ∥ B, A \| B |
| OR | operand completeness causes | The system must receive |
| ∥, \| | the expression to be complete. | and process either A or B. |
| Minus | The left operand must be | A −> B |
| Greater | complete before the right | The system must receive and |
| Than | operand can start receiving | process a signal A. Only then |
| −> | signals. The expression is | a signal B can be accepted. |
| | considered complete when the | Once B is received and |
| | right operand is complete. | processed the expression is |
| | | complete. |
| Asterisk | An infinite number of signals | *A |
| * | matching the operand can be | The system will accept any |
| | received and processed. The | signal A as long as it is |
| | expression is never complete. | not processing a previous A |
| | | signal. |
| Brackets | A finite number of signals | A[8] |
| [ ] | matching the operand can be | the system must receive and |
| | received and processed. The | process eight, A signals. |
| | expression is considered | |
| | complete after. | |
| Lambda | Upon receipt and completion | (A) => {do_something( );} |
| ( ) => { } | of an operand, a custom code | The system will execute the |
| | will be executed. The | do_something( ) statement |
| | expression shall be deemed | after receiving and processing |
| | complete after such code is | a signal A. |
| | complete. The code | |
| | completeness semantic is | |
| | identical to signal code. | |

The completion set algorithm is as follows:

Herein, we present an algorithm to evaluate concurrent expressions based on completion sets. In said algorithm, expression completeness is determined by the termination of a subset of the concurrent object process alphabet. Said alphabet includes user declared signals, compiler generated signals and any other artifact capable of capturing the termination (either success or failure) of a related process. Said algorithm works by identifying sets of process Which termination cause a concurrent expression to be considered complete.

In Appendix 1, section 3, a process calculus is introduced to provide the mathematical foundation for the present invention. Said calculus extends boolean algebras by adding one indeterminate value to signify that results haven't yet arrived. In the completion set algorithm, we assume the boolean true value to represent a process that has succeeded. Conversely, false will represent such process as not finished. A separate mechanism is provided to handle process failure. As described, it is clear that any completion set which values are all true terminates the evaluation of a concurrent expression with a result value of success.

Process failure is handled, under the completion set algorithm, at set level. It should be clear that the failure of any process within a set renders said set as impossible to produce a successful evaluation. Said algorithm will then remove said set from the list of all valid sets. Once said list becomes empty, the expression terminates with a result of failure. Some of the introduced concepts will be shown in the following example expression (signals in caps):

A & ( B | (C) =>
{

D −> E

do_something( );
})

In the above example is clear that:

The signal A must be present in all completion sets due to the & operator.
All completion sets must contain either B or the termination of lambda expression (C)=>{. . . }
Signals D and E are irrelevant to the completion sets since they only affect the completion of the lambda expression.
A completion signal L must be created, triggered by the completion of the lambda expression and included in the completion sets.
The final completion set is [A, B], [A, L], meaning the expression shall be completed when the signal A is processed and either a signal B is processed or the signals necessary to complete the lambda expression are processed.

The present invention shall keep multiple such sets active at any particular time and said sets can be considered to be the state of the concurrent expression. This state can be clearly modified (expanded or contracted) by the execution of code associated with a signal as said signal is received. Shall said code contain concurrent expressions a completion set will be constructed for said expressions and its completion will consider said signal to be completed and as such able to modified the global state of the expression.

Formally, the completion set is built by a bottom-up traversal of the expression tree where non logical operators are grouped into single signals (sometimes by creating anonymous signals) and added to temporary sets. Logical operators combine its left and right sets in the following mariner:

Logical. AND creates the set [Left x Right], where the x operator is the cartesian product operator in set theory. For example: shall the left set be [A, B] and the right set [C, D], the resulting set would be: [A, C], [A, D], [B, C], [B, D]
Logical OR creates the set [Left U Right] where the U operator is the union operator in set theory. For example: shall the left set be [A, B] and the right set [C, D], the resulting set would be: [A, B], [C, D]

Once this process reaches the root of the expression tree, the resulting set shall be the completion set of the expressions and the completeness of all signals included in any of the subsets of the completion set shall trigger the completion of the concurrent expression. The same process can be applied to obtain a fail set, described as a similar set which completion leads the concurrent expression to never be able to complete and thus fail.

During execution by a runtime, as defined herein; said runtime would only have to check the completeness of a finite such set in order to detect the expression completeness or its failure, which shall be deemed a trivial task. Furthermore, the information needed for those sets is minimal (a process can represented with at most 2 bits) which leads to a small memory footprint as well as fast execution times. Further, those skilled in the art will recognize the algorithm described herein can be easily implemented in a non-blocking fashion.

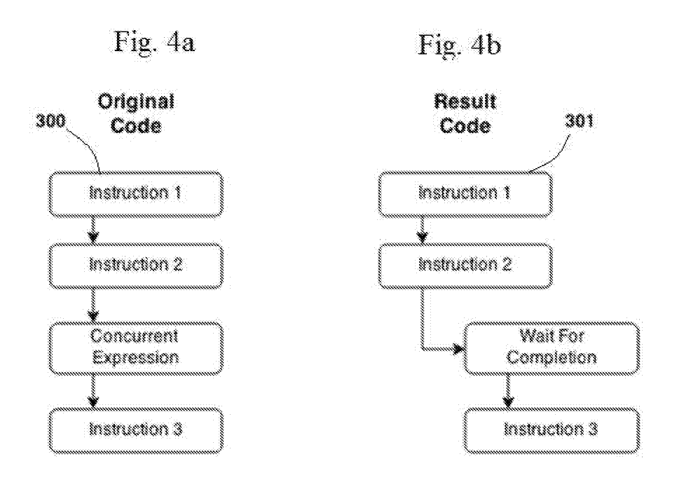

Since completion sets are evaluated with logical operations, an electronic circuit representing a concurrent expression can be synthesized automatically from said sets. FIGS. 4A and 4B depict the electronic circuit resulting from the example given in [00113]. Signals As, Bs and Ls in 801 represent incoming signals signifying the success of their respective processes. Conversely, in 804, Af, Bf and Lf represent incoming signals signifying the failure of said processes. And array of logical AND gates, 802, is used to determine single-set completion once all it's processes has succeeded. A logical OR gate, 803, is used to ensure that the success of a single completion set results in the success of the concurrent expression. A similar circuit is presented to calculate the failure of a concurrent expression. Logical OR gates, 805, are used to ensure that the failure of a single process renders a completion set as failed. A logical AND gate, 806, is used to ensure that once all completion sets fail the concurrent expression will fail as well. Those skilled in the art will recognize that the amount of processes in a completion set is irrelevant to the correct generation of logical gates. Furthermore, also the complexity of the processes is irrelevant, as complex processes can be represented with an outgoing signal and, once finished, one incoming signal into the circuit representing success or failure. Furthermore, said skilled in the art will recognize the ability of such circuits to be combined by, for instance, using the success and failure outputs as inputs to another expression's circuit.

The concurrent expression tree algorithm is as follows:

Herein, we present an algorithm to evaluate concurrent expressions based on expression trees. Said algorithm consists of creating a traditional expression tree with all logical operands in a concurrent expression. The leafs of said tree will contain the outcomes of actual processes while non-leaf nodes will contain operators. Each node will store the state of node, represented as either success, failure or not-yet-received as per the process calculus previously cited. Once the state on a leaf node changes from not-yet-received (as the result of an incoming signal), the algorithm will walk the tree up evaluating parent operators. Said evaluation, as shown in FIG. 1 of Appendix 1, will propagate until it reaches the root of the expression tree. A change in state on the root node will produce the final of the expression. In section 4 of Appendix 1 a computational model if offered for this algorithm that is proven to be non-blocking and deterministic.

An embodiment of the present invention, shown in FIG. 1 is a system and compilation method for extending existing programming languages by means of concurrent expressions, the system and method comprising: Providing at least one processor (10) that uses at least one module 14, 18 and 20 to extend a programing language by means of a concurrent expressions, each module is stored on at least one computer readable medium; providing a compilation service module 14 capable of extracting features 24 from a source code written in a programming language, particularly concurrent expressions 24 intended for a concurrency control; providing a transformation service 20 module that converts the programming language features into a computer readable entities 22 executable by the at least one processor 10; and providing a runtime service 18 module supporting an evaluation of the concurrent expressions 26, particularly as described by an output of the transformation service 20.

In another embodiment of the present invention, the extended programing languages are object oriented.

In still another embodiment of the present invention, the extended programing languages support at least one signal and at least one concurrent object, wherein each signal represents an incoming or an outgoing invocation to the concurrent object. Each signal may be automatically extracted as a public interface of the concurrent object.

In yet another embodiment of the present invention, the runtime service routes a messages, such as those in a network, as signals from and to a concurrent object.

In another embodiment of the present invention, the concurrent objects support more than one concurrent expression being concurrently evaluated.

In another embodiment of the present invention, the transformation service output is a concurrent source code and the runtime service is a compiler or an interpreter.

In another embodiment of the present invention, the runtime service evaluates the concurrent expressions in a non-blocking fashion.

In another embodiment of the present invention, the transformation service converts the concurrent expression tree into an equivalent data structure that is concurrently updated with the results of at least one process operand until the satisfaction of the concurrent expression.

In another embodiment of the present invention, the transformation service converts the concurrent expression into a series of bits and binary operations that update with the results of the process operands until the satisfaction of the concurrent expression.

In another embodiment of the present invention, the transformation service converts the concurrent expression into a hardware design representing the concurrent expression.

While the inventor's above description contains many specificities, these should not be construed as limitations on the scope, but rather as an exemplification of several preferred embodiments thereof. Many other variations are possible. Accordingly, the scope should be determined not by the embodiments illustrated, but by the appended claims and their legal equivalents.

What is claimed is:

1. A system and compilation method for extending existing programming languages by means of concurrent expressions, the system and method comprising:
Providing at least one processor that uses at least one module to extend a programing language by means of a concurrent expressions, each module is stored on at least one computer readable medium;
providing a compilation service module capable of extracting features from a source code written in a programming language, particularly concurrent expressions intended for a concurrency control;
providing a transformation service module that converts the programming language features into a computer readable entities executable by the at least one processor; and
providing a runtime service module supporting an evaluation of the concurrent expressions, particularly as described by an output of the transformation service.

2. The system and compilation method for extending existing programming languages by means of concurrent expressions of claim 1, wherein the extended programing languages are object oriented.

3. The system and compilation method for extending existing programming languages by means of the concurrent expressions of claim 2, wherein the extended programing languages support at least one signal and at least one concurrent object, wherein each signal represents an incoming or an outgoing invocation to the concurrent object.

4. The system and compilation method for extending existing programming languages by means of the concurrent expressions of claim 3, wherein each signal is automatically extracted as a public interface of the concurrent object.

5. The system and compilation method for extending existing programming languages by means of concurrent expressions of claim 3, wherein the runtime service routes a messages, such as those in a network, as signals from and to a concurrent object.

6. The system and compilation method for extending existing programming languages by means of concurrent expressions of claim 3, wherein concurrent objects support more than one concurrent expression being concurrently evaluated.

7. The system and compilation method for extending existing programming languages by means of concurrent expressions of claim 1, wherein the transformation service output is a concurrent source code and the runtime service is a compiler or an interpreter.

8. The system and compilation method for extending existing programming languages by means of concurrent expressions of claim 1, wherein the runtime service evaluates the concurrent expressions in a non-blocking fashion.

9. The system and compilation method for extending existing programming languages by means of concurrent expressions of claim 1, wherein the transformation service converts the concurrent expression tree into an equivalent data structure that is concurrently updated with the results of at least one process operand until the satisfaction of the concurrent expression.

10. The system and compilation method for extending existing programming languages by means of concurrent expressions of claim 1, wherein the transformation service converts the concurrent expression into a series of bits and binary operations that update with the results of the process operands until the satisfaction of the concurrent expression.

11. The system and compilation method for extending existing programming languages by means of concurrent expressions of claim 1, wherein the transformation service converts the concurrent expression into a hardware design representing the concurrent expression.
